(19) United States
(12) Patent Application Publication
(10) Pub. No.: US 2006/0114231 A1
(43) Pub. Date: Jun. 1, 2006

(54) Optical wireless mouse power saving feature

(75) Inventor: Fook On Koh, Singapore (SG)

Correspondence Address: CREATIVE LABS, INC.;LEGAL DEPARTMENT, 1901 MCCARTHY BLVD, MILPITAS, CA, 95035, US

(73) Assignee: Creative Technology Ltd.

(21) Appl. No.: 10/987,046

(22) Filed: Nov. 12, 2004

(51) Int. Cl. G09G 5/08

(52) U.S. Cl. 345/166

(57) ABSTRACT

A wireless pointing device includes a push button switch, an optical sensor circuit, and a processor. The processor is configured to transmit to the optical sensor circuit a logic high signal in response to depression of the push button switch for a period greater than or equal to the predetermined first period of time and to transmit a logic low signal in response to depression of the push button switch for a period less than the predetermined first period. The optical sensor circuit responds to the logic high signal by entering a power saving mode wherein an optical sensor in the optical sensor circuit is decoupled from a power source.

### BACKGROUND OF THE INVENTION

1. Field of the Invention

The present invention relates to pointing devices. More particularly, the present invention relates to power saving circuits for wireless optical mice.

2. Description of the Related Art

The personal computer market has evolved dramatically in terms of portability and user access. Portable laptop computers have garnered increasing shares of the market. With this increased emphasis on portability, more stringent demands have been placed on batteries and power saving features to extend battery life. Even with peripheral pointing devices, portability has become an issue for both laptops and desktop computers. Wireless optical pointing devices such as mice have also grown in popularity. One drawback to the use of wireless optical mice is the increased power consumption even during sleep modes.

Typically, conventional wireless or cordless mice include a power saving circuit that is initiated after a predetermined period of inactivity. These circuits are conventionally designed to cause the mouse to emerge from the power saving mode upon initiation of activity. Unfortunately, the determination that mouse activity has commenced requires that the mouse consume considerable battery power in a standby state. That is, in order to determine that mouse activity has recommenced, a series of optical pulses are sent periodically. Although the frequency of these emitted pulses is considerably less than the corresponding frequency during the active mode, the pulses are still emitted at several times per second and result in depletion of the battery faster than desired. It is therefore desirable to provide an improved power saving circuit for wireless pointing devices.

### SUMMARY OF THE INVENTION

The present invention provides a wireless optical pointing device for use with a computer. The wireless pointing device includes a push button switch, an optical sensor circuit, and a processor. The processor is configured to transmit to the optical sensor circuit a logic high signal in response to depression of the push button switch for a period greater than or equal to the predetermined first period of time and to transmit a logic low signal in response to depression of the push button switch for a period less than the predetermined first period. The optical sensor circuit responds to the logic high signal by entering a power saving mode wherein an optical sensor in the optical sensor circuit is decoupled from a power source. Further, the optical sensor circuit responds to the logic low signal by entering an operating mode from the power saving mode by coupling an optical sensor in the optical sensor circuit to the power source.

According to one embodiment, the processor is programmable by the user of the device to customize the response of the optical sensor circuit and the duration of the depression of the switch to generate low and high logic levels. According to yet another embodiment, the push button switch is one of a membrane switch, a tactile membrane switch, and a touch sensitive switch. These and other features and advantages of the present invention are described below with reference to the drawings.

### BRIEF DESCRIPTION OF THE DRAWINGS

FIG. 1 is a flowchart illustrating operation of a power saving optical sensor circuit in accordance with one embodiment of the present invention.

FIG. 2 is a block diagram illustrating electrical configuration of a wireless pointing device in accordance with one embodiment of the present invention.

FIG. 3 is a diagram illustrating a construction of a wireless pointing device in accordance with one embodiment of the present invention.

### DETAILED DESCRIPTION OF PREFERRED EMBODIMENTS

Reference will now be made in detail to preferred embodiments of the invention. Examples of the preferred embodiments are illustrated in the accompanying drawings. While the invention will be described in conjunction with these preferred embodiments, it will be understood that it is not intended to limit the invention to such preferred embodiments. On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well known circuit portions have not been described in detail in order not to unnecessarily obscure the present invention.

It should be noted herein that throughout the various drawings like numerals refer to like parts. The various drawings illustrated and described herein are used to illustrate various features of the invention. To the extent that a particular feature is illustrated in one drawing and not another, except where otherwise indicated or where the structure inherently prohibits incorporation of the feature, it is to be understood that those features may be adapted to be included in the embodiments represented in the other figures, as if they were fully illustrated in those figures. Unless otherwise indicated, the drawings are not necessarily to scale. Any dimensions provided on the drawings are not intended to be limiting as to the scope of the invention but merely illustrative.

Various embodiments of the present invention provide a wireless optical mouse with an improved power saving feature. In a preferred embodiment, the pointing device is a wireless optical mouse having at least an operating mode, a sleep mode, and a powered down mode. During the operating mode, the optical mouse consumes the most current, for example about 21 mA according to one embodiment. In the sleep mode, determined by inactivity of the mouse, the optical sensor in this embodiment consumes about 4 mA. In the powered down mode, initiated preferably by sending an active high signal (i.e., logic high), the optical sensor circuit consumes approximately 0.2 mA. This residual power is required to enable the optical sensor circuit to respond to a wakeup call from the optical mouse controller circuit. Preferably, the power consumption in the powered down state is very low, about 1% or less of the power consumption during the operating mode.

Typically, optical mouse pointing devices incorporate a light source and an optical sensor to receive the reflected images to indicate relative motion between the imaging surface and the pointing device. Power provided to the light source consumes the majority of that consumed by the pointing device. In order to support 800 dpi resolution, for example, optical sensing circuits may require 1400 frames/sec. to be processed by the optical sensor circuit. Although optical pointing devices typically provide for a low power (i.e., sleep) mode after a specified period of inactivity, the light source consumes a great deal of power even during the sleep modes. The present invention in various embodiments enables the user to turn off the mouse to a very low power state through the use of a push button switch. Preferably this selection is made during periods of anticipated extended inactivity. Preferably this user power down feature is incorporated with conventional sleep modes, i.e., modes where the light emitting source still generates a reduced number of “light pulses” per second but still is available for pointing functions upon detection of the mouse movement. By pressing the push button switch when in the powered down mode, the mouse returns to an operating made substantially instantaneous with the depression of the switch.

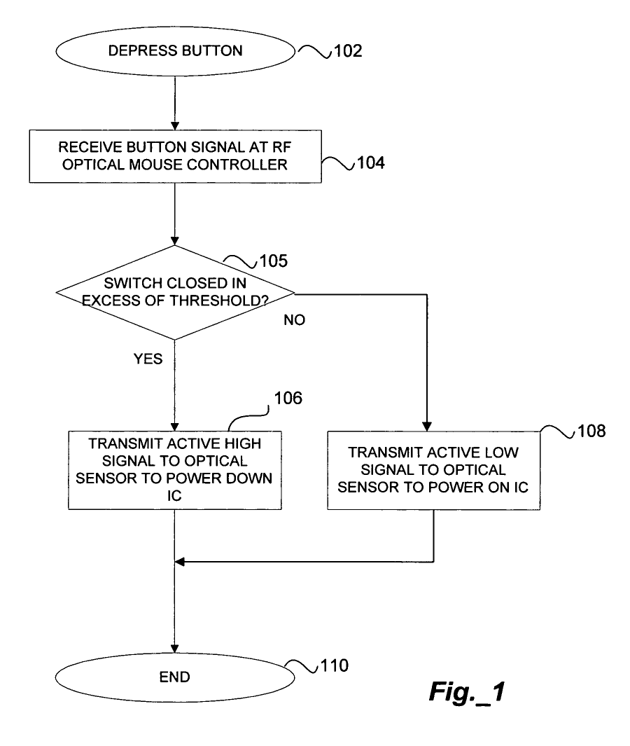

In general, the push button switch is used to generate high and low logic signals in a controller to respectively power down and return an optical sensor circuit from a powered down state. FIG. 1 is a flowchart illustrating operation of a power saving optical sensor circuit in accordance with one embodiment of the present invention. Initially, in operation 102, the push button switch is depressed to generate a signal. Preferably, the signal from the push button switch is received by the mouse controller in operation 104. In order to control entry into power saving modes, the controller is preferably configured to generate an output signal for transmission to an optical mouse sensor. That is, the controller is configured to generate a logic low or high signal in response to a determination as to whether the push button switch has been closed for a period greater than a predetermined time period. It is noted that the logic designations here are illustrative and not limiting. That is, the controller and optical sensor chip could as well be configured such that a low logic level is provided to the optical sensor chip to power it down and a high logic level to return it to an operating mode. Next, in operation 105 a determination is made by a suitably configured controller as to whether the switch has been closed for a time period in excess of the predetermined threshold. If the duration of the period is in excess of the threshold, an active high signal is transmitted to the optical sensor circuit in operation 106. If the duration of the switch closure is less than the predetermined threshold, an active low signal is transmitted to the optical sensor circuit in operation 108. Those of skill in the relevant arts are familiar with logic designs necessary for generating output logic signals in response to received input signals of various durations as described by the guidelines provided herein. Hence, complete details as to such circuitry will not be provided here. Preferably, however, the controller includes non-volatile memory to store program code to enable these functions to be performed. Other methods of configuring the controller include, but are not limited to application specific integrated circuit (ASIC) chips with the logic hard wired in the configuration of the chip and programmable logic devices, including FPGA's. These examples are intended to be illustrative and not limiting as to the scope of the invention in its various embodiments. The process ends at operation 110 with the controller awaiting further signals from the push button switch.

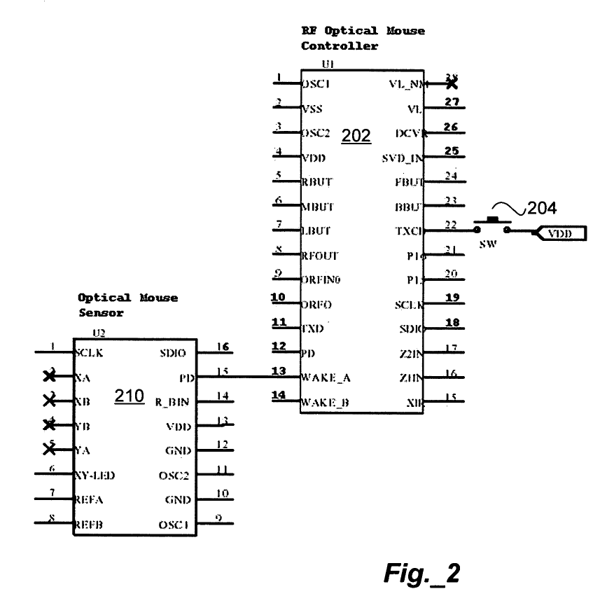

FIG. 2 is a block diagram illustrating electrical configuration of a wireless pointing device in accordance with one embodiment of the present invention. The block diagram illustrated is but one example of a suitable electrical circuit for performing the logic controlled switching as described in various embodiments of the present invention. As described above, the controller is preferably configured to receive a signal from a push button switch, such as switch 204. Preferably, the switch 204 is electrically connected to a power source (V_{DD}) such that upon depression of the switch 204, a voltage signal corresponding to V_{DD} is transmitted to input pin TXCB of the controller 202.

By providing the controller with non-volatile memory (RAM) the program code to enable the operations of the controller may be changed to conform to customer and user requirements. Thus, instead of the controller chip 202 responding to only a factory set default predetermined period, the predetermined threshold for powering down the optical sensor chip may be customized for particular customers. Customizaton may include changing the duration of the time required in depressing the switch to cause powering down of the optical sensor or even requiring that the switch be depressed multiple times before a control signal is sent for powering down the optical sensor.

For example, a factory preset may set the threshold at three seconds (a default value). The customer may desire that the wireless optical mouse powers down after a shorter period and thus request a reconfigured mouse to respond to a threshold of 2 seconds (or some other value). For example, according to one embodiment, the predetermined period falls within the range from 0.5 to 5 seconds. Preferably, the optical controller chip includes embedded memory for storing a configuration (in firmware) for the push button and power up/power down operations. Methods for programming RAM in embedded devices or other programmable devices are known to those of skill in the relevant arts and hence will not be described in full detail here.

The controller circuit 202 measures the duration of the V_{DD} logic high signal received from the push button switch and in response transmits either a logic low signal or a logic high signal to the optical mouse sensor chip 210. For example, in FIG. 2, input pin PD on chip 210 receives the “power down” signal (an active high signal, for example). In the configuration shown, the WAKE_A pin provides I/O for the control Power Down Signal” of the optical sensor. When powered down, the chip 210 awaits the push button press signal to return to the active or operating mode. In this state, the chip 210 will not respond to any signals on other pins except for the PD pin (pin 15).

This diagram illustrates only the pertinent connections between the two illustrated chips, i.e., for the described optical mouse the power saving control functions directed to the optical sensor IC 210. For clarity of illustration, connections to the other pins on the chips are not illustrated. Preferably, the optical sensor chip 210 provides several functions including control of the laser light emission, capturing of the images, and decoding of the data. Using clean control signals at the input of the chip 210 avoids many of the problems of unknown or unpredictable states using other switching/control arrangements.

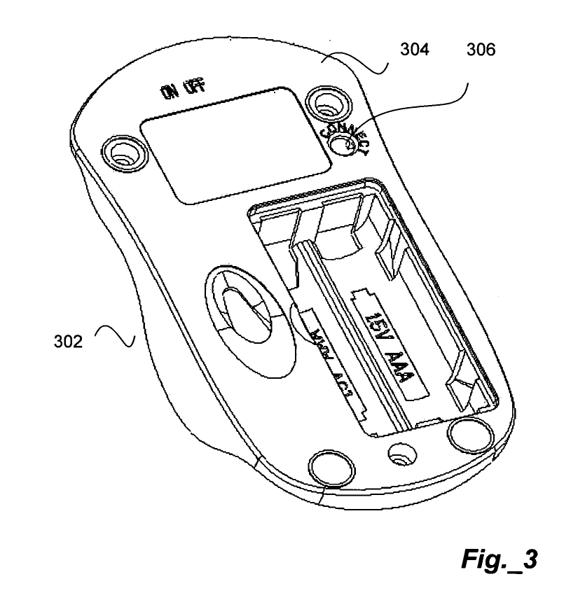

FIG. 3 is a diagram illustrating a construction of a wireless pointing device in accordance with one embodiment of the present invention. According to a preferred embodiment, the push button switch 306 is located on the underside 304 of the mouse 302. When depressed for a duration exceeding the predetermined threshold, power is disconnected from the optical sensor. Residual power is still supplied to the optical sensor circuit to enable detection of the logic signal provided on pin PD (see FIG. 3) to return the mouse to an operating mode. As shown, the push button switch in this embodiment serves a dual function. That is, it also permits initial setup between the mouse (and its internal RF transmitter) with a receiver connected to a computer. For example, an initial setup procedure (for example, when a battery is changed) might involve first pressing a button on the receiver to detect the mouse and in turn pressing the connect button 306 to perform a handshaking operation between the mouse rf transmitter and the receiver. Once initialized in this manner, the connect or push button switch 304 is ready to respond to depression of the switch to generate control signals to be sent to optical sensor chip 210 as described above. By using the switch to generate control signals for transmission to the optical sensor, the switch may perform dual functions, thus saving in hardware and manufacturing costs.

By providing the power switch on the underside of the mouse and in a recessed position, inadvertent turning on of the mouse is minimized. Moreover, by isolating the push button switch and its direct power supply connection (V_{DD}) from the optical sensor circuit, transient noise in the RF signal sent to the host computer is minimized. Typically, when mechanical switches are closed, a transition in voltage occurs. That is, a ramp up or ramp down present on the input pin will subject the pin to a floating unknown state for a period of time. The isolation provided in embodiments of the present invention eliminate the transient noise at the input of optical sensor chip 210 and avoid causing the circuit to enter an unstable state (i.e., analogous to a hardware switch at a middle point). Instead, the signal pulse provided to the chip 210 is short and clean, without mechanical contact bouncing noise.

According to alternative embodiments, the push button switch may be located on the topside of the mouse, i.e., the surface of the mouse including the activation buttons. In fact, the scope of the present invention is intended to extend to pointing devices having push button switches located on any surface of the mouse, whether accessible or inaccessible from a normal operating position, to include the exterior surfaces as well as in portions recessed into the interior. Preferably, the push button switch or other contact or contact less switching mechanism is located such that inadvertent turning on or off is avoided. For example, the “switch” may be located on the side of the mouse but recessed. Preferably, the push button switch comprises a membrane switch or a tactile membrane switch. Tactical membrane switches typically include a metal or metal-like dome to provide a clicking sensation when the button is depressed. These types of switches provide greater reliability and less wear as compared with conventional mechanical slide switches. Alternatively, any contact or contact-less detection device may replace the push button switch 204. By connecting the switch between the power supply (V_{DD}) and the controller chip 202, a cleaner logic signal is provided to the optical sensor chip and in turn greater flexibility in the types of contact or contact less switches or detection devices is available. For example, touch sensitive switches may be used to initiate the power-down and power up operations. Placing the switch 204 at the input pin TXCB of the controller chip 202 avoids voltage surges that would occur in connecting the power supply voltage and switch directly to the input pin PD of the optical sensor chip 210.

The foregoing description describes several embodiments of a wireless pointing device employing improved power saving circuitry. While the embodiments describe details of wireless optical pointing devices, the invention is not so limited. The scope of the invention is intended to extend to all pointing devices having wireless or cordless features, such as including mechanical mouse peripherals. By configuring a wireless pointing device in accordance with the embodiments described, battery consumption may be reduced especially for planned inactive periods while providing a separate sleep state for immediate response during relatively active periods. Further, providing the control signals as described to the input pin of the optical sensor chip avoids instability problems that might result form directly providing a mechanical switch in the power supply of the optical sensor. The latter circuits are not recommended due to the resulting sudden surges of power generated on the optical sensor chip and the potential for placing many of the I/O pins of the chip in unpredictable states.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A wireless pointing device, the device comprising:
a push button;
an optical sensor circuit; and
a controller configured to transmit to the optical sensor circuit a logic high signal in response to depression of the push button switch for a period greater than or equal to the predetermined first period of time and to transmit a logic low signal in response to depression of the push button switch for a period less than the predetermined first period.

2. The device as recited in claim 1 wherein the optical sensor circuit is further configured to respond to the logic high signal by entering a power saving mode wherein an optical sensor in the optical sensor circuit is decoupled from a power source.

3. The device as recited in claim 2 wherein the optical sensor circuit is further configured to respond to the logic low signal by entering an operating mode from the power saving mode by coupling an optical sensor in the optical sensor circuit to the power source.

4. The device as recited in claim 3 wherein the power consumption by the optical sensor circuit in the power saving mode is about 1% or less of the power consumption during the operating mode.

5. The device as recited in claim 1 wherein the controller is programmable such that the predetermined first period falls within the range from 0.5 to 5 seconds.

6. The device as recited in claim 1 wherein the controller is programmable to alter the generation of logic signals sent to an input terminal of the optical sensor circuit.

7. The device as recited in claim 1 wherein the push button switch is one of a membrane switch, a tactile membrane switch, or a touch sensitive switch.

8. The device as recited in claim 1 wherein the controller comprises a non-volatile memory section for storing code to control the response of the controller to a signal received from the push button switch.

9. An optical mouse pointing device, the device comprising:
a contact or contact less detection device;
an optical sensor circuit; and
a controller configured to transmit to the optical sensor circuit an active logic signal in response to depression of the detection device for a period greater than or equal to the predetermined first period of time and to transmit a logic signal of an opposite type in response to depression of the detection device for a period less than the predetermined first period.

10. The device as recited in claim 9 wherein the active logic signal is a high signal.

11. The device as recited in claim 9 wherein the active logic signal is a low signal.
